(19) United States
(12) Patent Application Publication
(10) Pub. No.: US 2003/0210220 A1
(43) Pub. Date: Nov. 13, 2003

(54) Shift register apparatus and display apparatus

(75) Inventor: Hiroyuki Hebiguchi, Miyagi-ken (JP)

Correspondence Address: BEYER WEAVER & THOMAS LLP, P.O. BOX 778, BERKELEY, CA, 94704-0778, US

(73) Assignee: ALPS ELECTRIC CO., LTD.

(21) Appl. No.: 10/405,376

(22) Filed: Apr. 1, 2003

(30) Foreign Application Priority Data
May 10, 2002 (JP) 2002-135713

(51) Int. Cl. G09G 3/36

(52) U.S. Cl. 345/100

(57) ABSTRACT

A shift register apparatus of the present invention includes a generator for generating a plurality of clock signals having different phases, and a plurality of cascaded stages, each generating an output signal. Each of the stages includes an input transistor, an output transistor, a clamping transistor, and a pull-down transistor. The pull-down transistor is a diode-connected transistor, to which the same clock signal as the clock signal input to the output transistor is input.

### BACKGROUND OF THE INVENTION

1. Field of the Invention

The present invention relates to a shift register apparatus incorporated in a display apparatus such as a liquid crystal display for supplying a scanning signal, and to a display apparatus including the shift register apparatus.

2. Description of the Related Art

An active matrix liquid crystal display apparatus includes an array of video signal lines (source lines) and scanning signal lines (gate lines), and switching devices formed of thin-film transistors for driving the liquid crystal at each pixel are placed at the intersections of the video signal lines and the scanning signal lines. Scanning signals are applied to the scanning signal lines so that the scanning signal lines are sequentially scanned to temporarily render all the switching devices on one of the scanning signal lines conductive, and video signals are applied to the video signal lines in synchronization with the scanning of the scanning signal lines.

A shift register has a role of sequentially supplying the scanning signals to the scanning signal lines. FIGS. 7 through 9 illustrate a shift register of the related art. The shift register shown in FIGS. 7 through 9 has a plurality of stages. FIG. 7 is a circuit diagram of one stage, FIG. 8 is a circuit diagram of three stages, and FIG. 9 is a timing chart of the shift register.

As shown in FIG. 7, each of stages i−1, i, and i+1 is formed of a combination of four transistors and a single capacitor, and, advantageously, this structure prevents excessive stress on the transistors, leading to low deterioration in characteristics of the transistors. As shown in FIG. 8, in the stage i, a diode-connected input transistor 51 is connected with an output Gi−1 of the previous stage i−1, and an output electrode of the input transistor 51 is connected with a control electrode of an output transistor 52 and a clamping transistor 53. A pull-down transistor 54 is connected with an output electrode of the output transistor 52, and a capacitor 55 is connected between the control electrode and-output electrode of the output transistor 52.

In the shift register of such a structure, as shown in FIG. 8, a plurality of phase-shifted clock signals CKA, CKB, and CKC are input to the output transistors 52 of the stages i−1, i, and i+1, respectively, and the clamping transistor 53 of a certain stage receives the output of the stage two stages downstream. Referring to FIG. 9, in the stage i shown in FIG. 8, which is surrounded by a broken-line box, when the output Gi−1 of the previous stage is at a high level, the input transistor 51 is turned on and potential Vbi (control signal) of the control electrode of the output transistor 52 rises, thus causing the output transistor 52 to be turned on. When the clock signal CKB input to the output transistor 52 is at the high level, the output Gi of the stage i, which is at the high level, is output. Then, the output Gi+2 of the stage two stages downstream rises to the high level. When the output Gi+2 is input to the control electrode of the clamping transistor 53, the clamping transistor 53 is turned on, thus causing the potential Vbi of the control electrode of the output transistor 52 to fall back to a low level. In this way, the outputs Gi−1, Gi, and Gi+1 are sequentially output from the stages i−1, i, and i+1, respectively, and this mechanism can be used for, for example, a scanning circuit of a liquid crystal display apparatus.

However, in a shift register of the above-described structure, each pull-down device is formed of a transistor, which cannot be switched while it is continuously conductive. The gate voltage of the pull-down transistor is maintained smaller than the other transistors of the clamping device etc., and suffers from low stress when it is continuously conductive, leading to no problem of deterioration in principle. However, since deterioration of the other transistors forming the shift register has been greatly improved, the deterioration of the pull-down device is no longer negligible. In addition, it is proved that noise from the load side of the output may cause the shift register to malfunction.

### SUMMARY OF THE INVENTION

Accordingly, it is an object of the present invention to provide a shift register apparatus having strong resistance to noise from the load side of the output and having low deterioration of devices, and a display apparatus including the shift register apparatus so that display failure can be prevented.

In one aspect of the present invention, a shift register apparatus includes a generator for generating a plurality of clock signals having different phases; and a plurality of cascaded stages, each stage generating an output signal. Each of the stages includes a switching device for receiving the output signal from the previous stage as a control signal, maintaining the control signal, and for outputting the output signal when a corresponding clock signal of the plurality of clock signals is input to the switching device; a clamping device for suppressing the control signal so that, after the output signal has been output from the switching device, generation of the output signal from the switching device is prevented; and a pull-down device connected to an output electrode of the switching device. The pull-down device includes a device having a rectifying effect, to which the same clock signal as the clock signal input to the switching device is input.

In the shift register apparatus of the present invention, when a clock signal input to the switching device is at a low level, that is, when generation of the output signal is not desirable, the rectifying effect of the pull-down device keeps the voltage of an output unit from being equal to or more than a threshold value of the pull-down device. If the voltage of the output unit is equal to or more than the threshold value of the pull-down device due to noise from the load side of the output, a current flows in the pull-down device. Therefore, the noise equal to or more than the threshold value of the pull-down device can be eliminated. Furthermore, in the related art, a voltage is constantly applied to the gate of the pull-down transistor. In the present invention, on the other hand, the time for applying a voltage equal to or more than the threshold value to the pull-down device is reduced, thus reducing deterioration of the pull-down device.

Preferably, the clamping device has a function of pulling down the output signal from the previous stage.

With this structure, when generation of the output signal is not desirable, the voltage can be pulled down to a voltage not greater than the threshold value of the pull-down device.

Preferably, the clamping device is controlled by the output signal from the subsequent stage.

With this structure, the time for which the control signal is maintained can be minimized, thus reducing the time for which stress is placed on the transistors to the minimum and preventing deterioration of the transistors.

Preferably, the plurality of stages are grouped into a plurality of blocks, and the clock signals are sequentially supplied in units of blocks.

Since the clock signals are sequentially supplied in units of blocks, when a block is being driven, all the clock signals supplied to the other blocks are at a low level, and therefore the deterioration of the transistors can be further prevented.

In another aspect of the present invention, a display apparatus includes the above-described shift register apparatus. According to the present invention, the shift register apparatus for use in scanning of a display does not malfunction such that undesirable output pulses are repeatedly output at a clock cycle. In the display apparatus, therefore, display failure, which would otherwise occur due to refreshing of image signals at an undesirable refresh timing, etc., can be prevented.

### BRIEF DESCRIPTION OF THE DRAWINGS

FIG. 1 is a circuit diagram of one stage of a shift register apparatus according to a first embodiment of the present invention;

FIG. 2 is a circuit diagram of four stages of the shift register apparatus of the first embodiment;

FIG. 3 is a timing chart of the shift register apparatus of the first embodiment;

FIG. 4 is a schematic diagram of a shift register apparatus according to a second embodiment of the present invention;

FIG. 5 is a timing chart of the shift register apparatus of the second embodiment;

FIG. 6 is a circuit diagram of a liquid crystal display apparatus including the shift register apparatus of the present invention;

FIG. 7 is a circuit diagram of one stage of a shift register apparatus of the related art;

FIG. 8 is a circuit diagram of three stages of the shift register of the related art; and

FIG. 9 is a timing chart of the shift register of the related art.

### DESCRIPTION OF THE PREFERRED EMBODIMENTS

First Embodiment

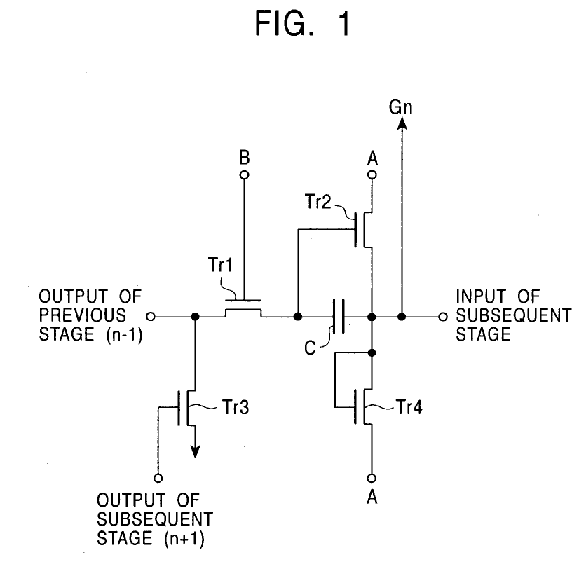

A first embodiment of the present invention is described below with reference to FIGS. 1 through 3.

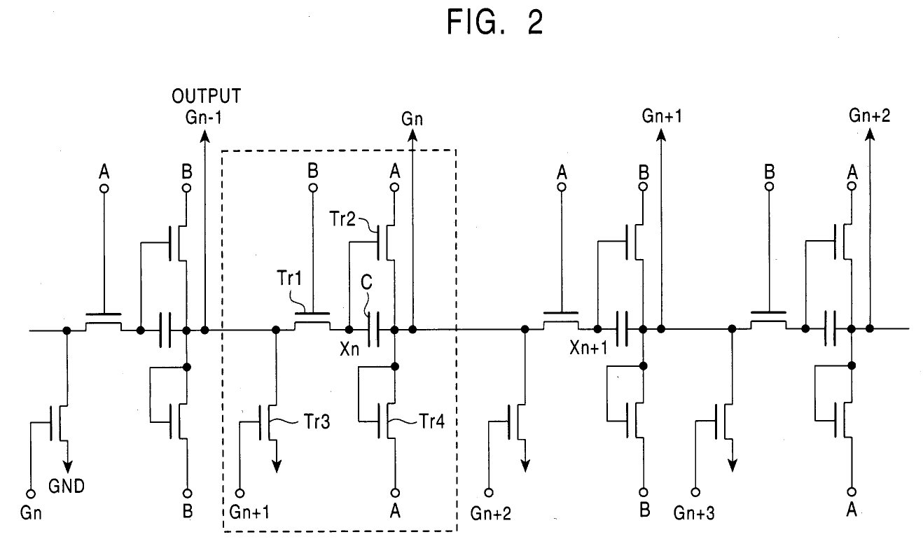

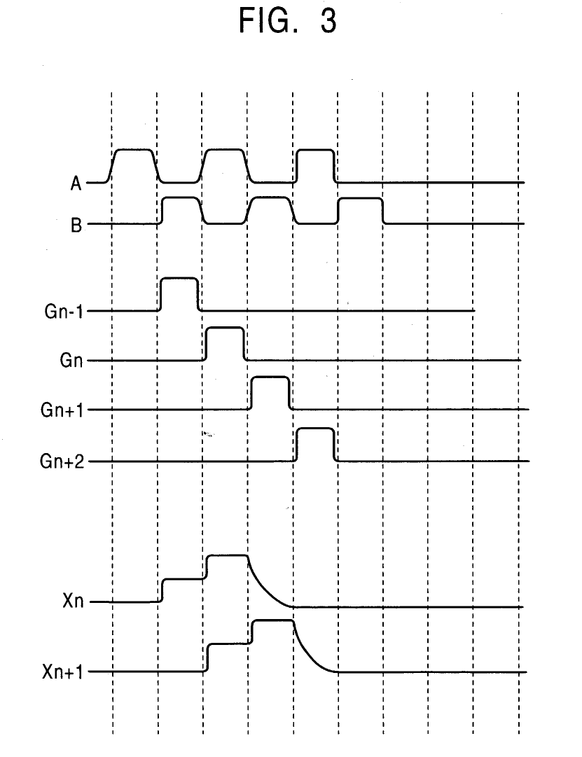

FIGS. 1 through 3 illustrate a shift register apparatus according to the first embodiment. The shift register apparatus includes a generator for generating a plurality of clock signals having different phases, and a plurality of cascaded stages. In particular, in the first embodiment, the generator generates two-phase clock signals having different phases. FIG. 1 is a circuit diagram of one of the stages, and FIG. 2 is a circuit diagram of four cascaded stages. FIG. 3 is a timing chart of the shift register apparatus, showing the waveform of clock signals A and B, output signals Gn−1 through Gn+2, a control signal Xn of stage n, and a control signal Xn+1 of stage n+1.

As shown in FIG. 1, each stage is formed of a combination of four transistors Tr1 through Tr4 and a single capacitor C. The input transistor Tr1 is connected with an output of the previous stage, and the clamping transistor Tr3 (clamping device) is connected with an input electrode of the input transistor Tr1. A control electrode of the output transistor Tr2 (switching device) is connected with an output electrode of the input transistor Tr1.

The pull-down transistor Tr4 (pull-down device) formed of a diode-connected transistor is connected with an output electrode of the output transistor Tr2. The pull-down transistor Tr4 is a device having a rectifying effect, to which the same clock signal as the clock signal input to the output transistor Tr2 is input. The capacitor C (switching device) is connected between the control electrode and output electrode of the output transistor Tr2. The capacitor C is used for maintaining the potential of the control signal of the output transistor Tr2, and functions as a bootstrap capacitor.

The shift register apparatus with the above-structured stages according to the first embodiment is driven by two-phase clocks. As shown in FIGS. 2 and 3, the output signal Gn−1 from the previous stage n−1 is input as a control signal to the stage n, and this signal is passed through the input transistor Tr1, which is controlled by the clock signal B, and is then stored in the capacitor C connected to the control electrode of the output transistor Tr2. In a state where the control signal is kept in the control electrode of the output transistor Tr2, the output transistor Tr2 outputs a pulse of the clock signal A as the output signal Gn. The output signal Gn is then input to the subsequent stage n+1 as a control signal.

As discussed above, the same clock signal A as that of the output transistor Tr2 is input to the pull-down transistor Tr4. Therefore, when the output signal Gn is output, the pulse of the clock signal A is at a high level, and the diode of the pull-down transistor Tr4 is reverse-biased, so that the pull-down effect does not work. In order to reduce the output signal Gn to a low level, when the clock signal A falls to the low level, the diode of the pull-down transistor Tr4 is forward-biased, so that the pull-down effect works. Next time the clock signal B and the output signal Gn+1 of the subsequent stage n+1 rise to the high level, the control signal kept in the control electrode of the output transistor Tr2 is discharged via the input transistor Tr1 and the clamping transistor Tr3.

In the first embodiment, when the clock signal A is at the low level, if noise occurs from the load side of the output, the pull-down effect of the pull-down transistor Tr4 controls the voltage so as not to be greater than a threshold value of the pull-down transistor Tr4, thus preventing malfunction of the shift register apparatus. When the clock signal B is at the low level, the input transistor Tr1 is turned off, thus preventing the noise from the load side of the output from entering the control electrode of the output transistor Tr2, resulting in low possibility of malfunction of the shift register apparatus.

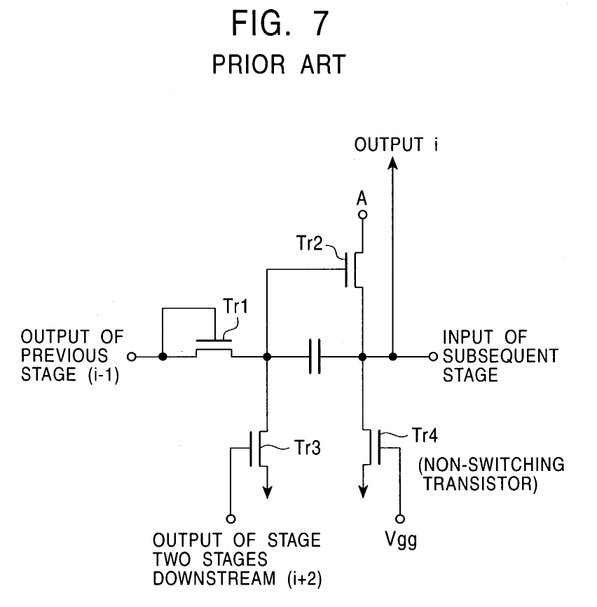

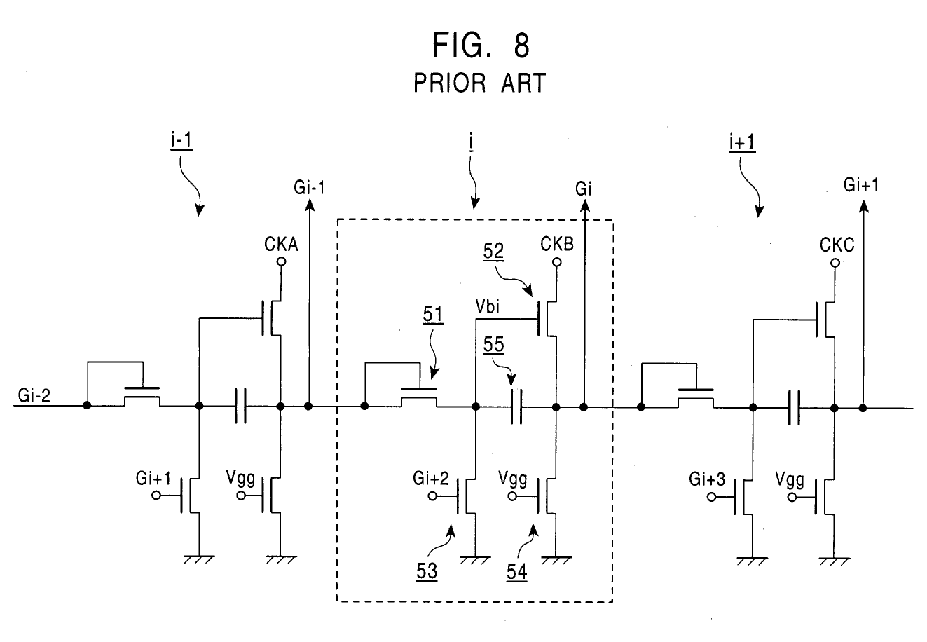

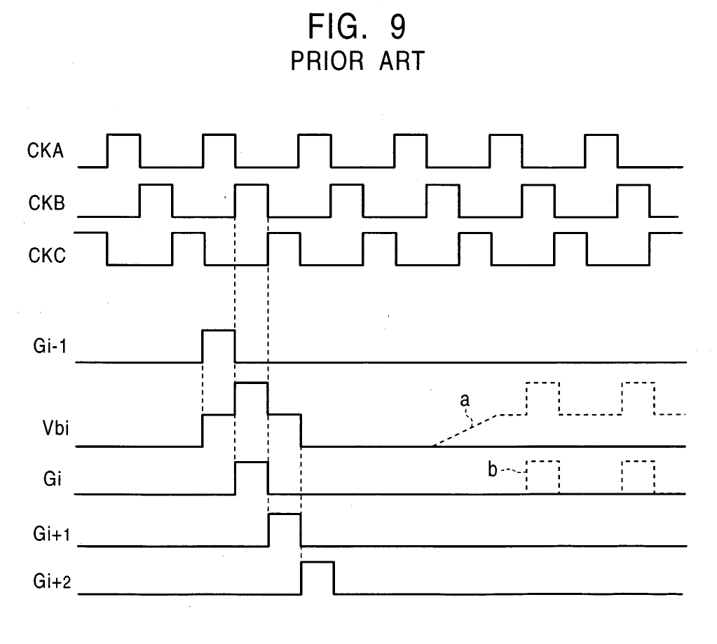

As depicted in FIG. 3, the control signal Xn of the stage n is written at the output timing of the previous stage n−1, and is discharged by the clamping transistor Tr3 at the output timing of the stage n+1. Thus, the control signal Xn is kept in the stage n for a period of about two clocks. In contrast, in the shift register apparatus of the related art shown in FIGS. 7 through 9, for example, the output transistor substantially serves also as a pull-down device so that the control signal of the stage i is kept for a period of three clocks or longer (a period from the stage i−1 to the stage i+1 or following stage) and the output transistor is turned on for a sufficient period when the output of the stage i falls to the low level. Thus, the clamping device is driven at the output timing of the stage i+2 or following stage to discharge the control signal. In the related art, therefore, the output transistor Tr2 must be turned on for a period of three clocks per output operation. In the first embodiment, on the other hand, the pull-down transistor Tr4 of the current stage and the clamping transistor Tr3 of the subsequent stage are used for pull-down operation, and the output transistor Tr2 must be turned on for a period of only two clocks, thus reducing the stress time, which causes deterioration of the transistors, to about ⅔ of that of the related art. In the shift register apparatus of the first embodiment, therefore, deterioration of the output transistor Tr2 can be prevented.

In addition, in the related art, since the pull-down transistor is used as a pull-down resistor, a voltage is constantly applied to the gate of the pull-down transistor. In the first embodiment, on the other hand, a clock signal is input to the pull-down transistor Tr4 formed of a diode-connected transistor, which shortens the time for applying a voltage equal to or more than the threshold value, thus sufficiently preventing deterioration of the pull-down transistor Tr4.

The clamping transistor Tr3 also functions to pull down the output of the previous stage n−1, and therefore a voltage that cannot be pulled down by the pull-down transistor Tr4 of the previous stage n−1 is successfully pulled down to the threshold value of the pull-down transistor Tr4 or lower.

Second Embodiment

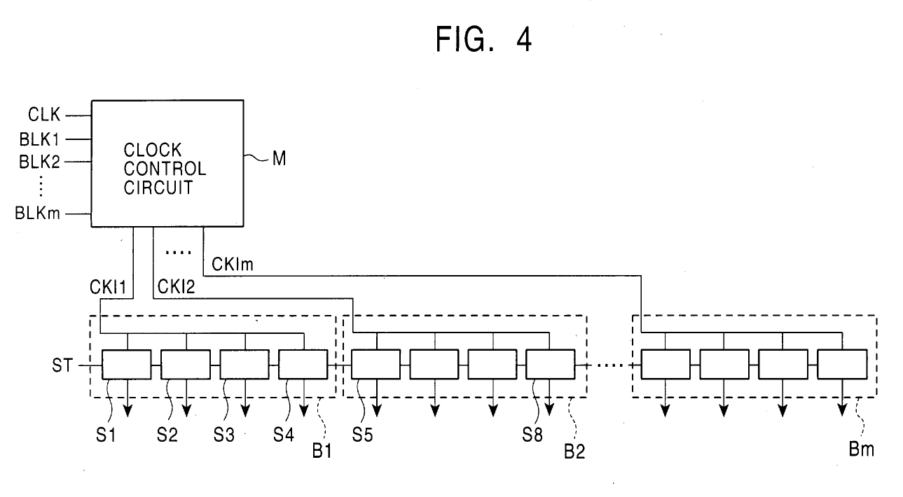

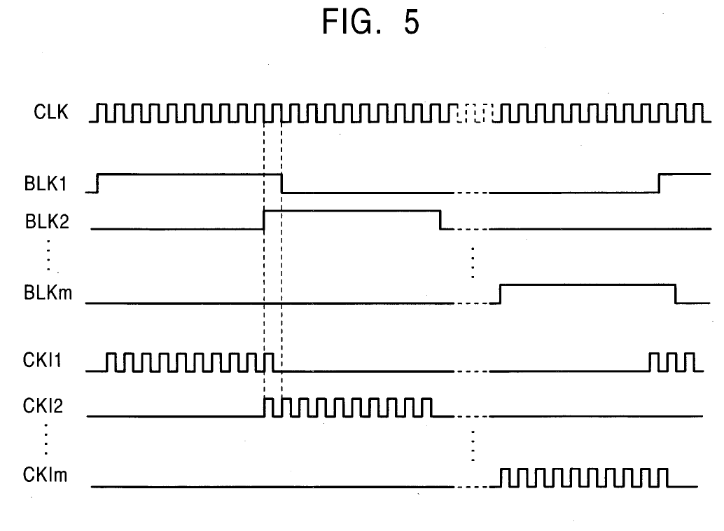

A shift register apparatus according to a second embodiment of the present invention has a structure in which a plurality of stages are grouped into a plurality of blocks and clock signals are sequentially supplied in units of blocks. FIG. 4 is a schematic diagram of the shift register of the second embodiment, showing that groups of four stages are arranged in m blocks. FIG. 5 is a timing chart of the shift register apparatus of the second embodiment. The specific structure of each stage is similar to that in the first embodiment, and a description thereof is thus omitted.

In the second embodiment, under the control of a clock control circuit M, when a block is being driven, all clock signals supplied to the other blocks are at a low level. Specifically, as shown in FIG. 5, when stages S1 through S4 of a block B1 are being driven, the clock signals A and B described above in the first embodiment are input to the block B1 as a clock signal CKI1, while low-level signals are input to the other blocks B2 through Bm as clock signals CKI1 through CKIm.

With this structure, the power consumption and the time for which stress is placed on the devices of the shift register apparatus, such as the transistors and the capacitors, can be reduced, thus preventing deterioration of the transistors. In the second embodiment, the clock signals A and B of the first embodiment are mostly at the low level, and, if noise occurs from the load side of the output, the pull-down effect of the pull-down transistor Tr4 can reliably controls the voltage so as not to be greater than the threshold value of the pull-down transistor Tr4. Furthermore, the input transistor Tr1 is mostly turned off, thus preventing the noise from the load side of the output from entering the control electrode of the output transistor Tr2, resulting in low possibility of malfunction of the shift register apparatus.

Display apparatus

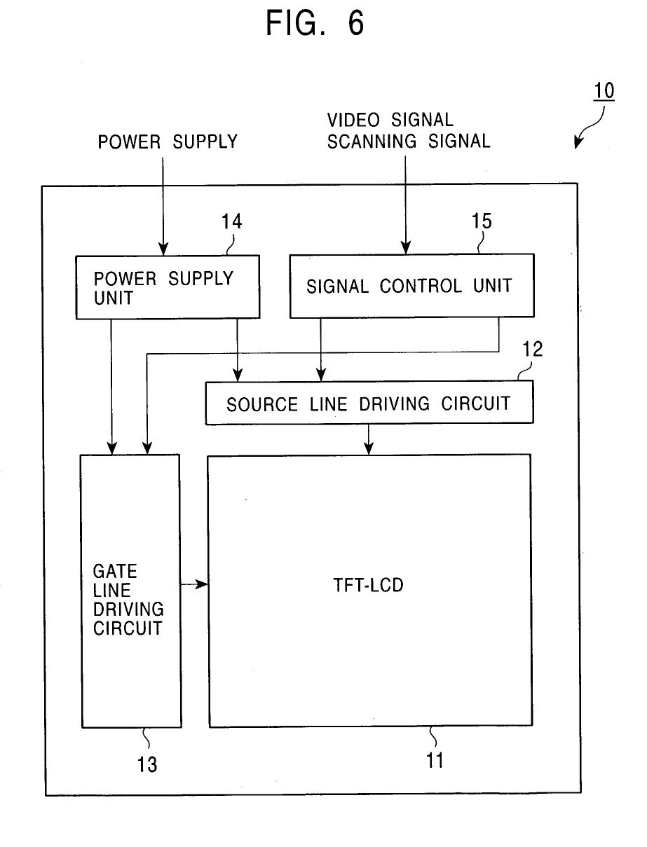

FIG. 6 is a circuit diagram of a liquid crystal display apparatus (display apparatus) 10 including the shift register apparatus of the aforementioned embodiments. As shown in FIG. 6, the liquid crystal display apparatus 10 includes a thin-film transistor liquid crystal display (TFT-LCD) 11, and the TFT-LCD 11 has an array of video signal lines (source lines) and scanning signal lines (gate lines), and thin-film transistors placed at the intersections of the video signal lines and the scanning signal lines for driving the liquid crystal at each pixel. The liquid crystal display apparatus 10 further includes a source line driving circuit 12 for driving the source lines, a gate line driving circuit 13 for driving the gate lines, a power supply 14 for supplying a power supply voltage and video signals to the source line driving circuit 12 and for supplying the power supply voltage and scanning signals to the gate line driving circuit 13, and a signal control unit 15.

In the liquid crystal display apparatus 10 of such a circuit structure, the shift register apparatus of the above-described embodiments is used for both the source line driving circuit 12 and the gate line driving circuit 13. The gate scan operation of the shift register apparatus in the gate line driving circuit 13 is described below, by way of example. A gate line driving transistor is connected with each of the gate lines, and the gate line driving transistors are driven one by one in the vertical direction by the shift register apparatus in the gate line driving circuit 13 so as to be conductive for one scanning period, starting from the uppermost transistor. As a result, when a gate line driving transistor connected to any gate line is rendered conductive in synchronization with a horizontal synchronization signal, all the thin-film transistors connected with this gate line are also rendered conductive. Thus, charges serving as image signals on the source lines are stored in capacitors of pixel electrodes.

The liquid crystal display apparatus 10 of the illustrated embodiment includes the above-noted shift register with better noise resistance, thus achieving a high reliability apparatus without display failure, which would otherwise occur due to refreshing of image signals at an undesirable refresh timing, etc.

The technical scope of the present invention is not limited to the aforementioned embodiments, and a variety of modifications may be made without departing from the spirit and scope of the present invention. For example, the diode-connected transistor is used as a pull-down device in the aforementioned embodiments; however, a diode itself may be used as a pull-down device.

In order to increase noise resistance, preferably, the threshold value of the pull-down transistor Tr4 is smaller than that of the other transistors, or the threshold value of the output transistor Tr2 is greater than the threshold value of the pull-down transistor Tr4. The threshold values may be controlled by doping transistor channels, by using a device capable of controlling the floating-gate potential with a plurality of control electrodes, such as a neuron-MOSFET (vMOS), to control the effective threshold values, or by using various devices for use in a non-volatile memory.

An alternative to such active approaches of controlling the threshold values is conceivable in view of the deterioration of the transistors. Since the output transistor Tr2 is bootstrapped and has a large voltage applied thereto at output time, the threshold value thereof is easily shifted. On the other hand, the threshold value of the pull-down transistor Tr4 is hardly shifted due to the effect of the present invention. This enables the threshold value of the output transistor Tr2 to become greater than that of the pull-down transistor Tr4 along with the deterioration of the transistors, thereby increasing noise resistance. It is to be understood that the threshold value of the output transistor Tr2 may be shifted only in a range which achieves a sufficient current driving capability required for pull-up operation.

What is claimed is:

1. A shift register apparatus comprising:
means for generating a plurality of clock signals having different phases; and
a plurality of cascaded stages, each stage generating an output signal,
wherein each of the stages includes:
a switching device for receiving the output signal from the previous stage as a control signal, maintaining the control signal, and for outputting the output signal when a corresponding clock signal of the plurality of clock signals is input to the switching device;
a clamping device for suppressing the control signal so that, after the output signal has been output from the switching device, generation of the output signal from the switching device is prevented; and
a pull-down device connected to an output electrode of the switching device; and
the pull-down device includes a device having a rectifying effect, to which the same clock signal as the clock signal input to the switching device is input.

2. A shift register apparatus according to claim 1, wherein the clamping device has a function of pulling down the output signal from the previous stage.

3. A shift register apparatus according to claim 1, wherein the clamping device is controlled by the output signal from the subsequent stage.

4. A shift register apparatus according to claim 1, wherein the plurality of stages are grouped into a plurality of blocks, and the clock signals are sequentially supplied in units of blocks.

5. A display apparatus comprising the shift register apparatus according to claim 1.
